(19) United States
(12) Patent Application Publication
(10) Pub. No.: US 2024/0249018 A1
(43) Pub. Date: Jul. 25, 2024

(54) PRIVACY ENHANCED MACHINE LEARNING OVER GRAPH DATA

(71) Applicant: International Business Machines Corporation, Armonk, NY (US)

(72) Inventors: Ambrish Rawat, Dublin (IE); Naoise Holohan, Maynooth (IE); Heiko H. Ludwig, San Francisco, CA (US); Ehsan Degan, Rancho Santa Margarita, CA (US); Nathalie Baracaldo Angel, San Jose, CA (US); Alan Jonathan King, South Salem, NY (US); Swanand Ravindra Kadhe, San Jose, CA (US); Yi Zhou, San Jose, CA (US); Keith Coleman Houck, Rye, NY (US); Mark Purcell, Naas (IE); Giulio Zizzo, Dublin (IE); Nir Drucker, Zichron Yaakov (IL); Hayim Shaul, Kfar Saba (IL); Eyal Kushnir, Kfar Vradim (IL); Lam Minh Nguyen, Ossining, NY (US)

(21) Appl. No.: 18/158,299

(22) Filed: Jan. 23, 2023

(51) Int. Cl. G06F 21/62

(52) U.S. Cl. CPC G06F 21/6245; G06F 21/6227

(57) ABSTRACT

One or more systems, devices, computer program products and/or computer-implemented methods of use provided herein relate to a process for privacy-enhanced machine learning and inference. A system can comprise a memory that stores computer executable components, and a processor that executes the computer executable components stored in the memory, wherein the computer executable components can comprise a processing component that generates an access rule that modifies access to first data of a graph database, wherein the first data comprises first party information identified as private, a sampling component that executes a random walk for sampling a first graph of the graph database while employing the access rule, wherein the first graph comprises the first data, and an inference component that, based on the sampling, generates a prediction in response to a query, wherein the inference component avoids directly exposing the first party information in the prediction.

### TECHNICAL FIELD

The present disclosure relates to analysis of private data, and more specifically to employing a framework for training a machine learning model where the framework allows for maintaining privacy of information comprised by the private data.

### BACKGROUND

Graph data is often used in existing data analytics processes in areas of social networking and healthcare. The graph data can be used, for instance, to solve problems related to pandemic forecasting, social influence prediction and/or vaccination likelihood. Existing techniques, such as stochastic gradient descent (SGD), can be employed to analyze the data. In connection therewith, existing techniques, such as differential privacy (DP) can be employed to aid in protecting information of the graph data that is private. However, existing techniques fail when employing graph data where data from one record, one entity and/or one neighbor influences data from multiple other records, entities and/or neighbors. This influence can occur in cases where nodes of the graph data are connected due to influence from other nodes. In such cases existing DP techniques will not be sufficient for combination with SGD because SGD is not privacy protective. That is, privacy of data will not be protected or implemented.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments described herein, systems, computer-implemented methods, apparatuses and/or computer program products can provide a process to analyze graph data while maintaining privacy of the data.

In accordance with an embodiment, a system can comprise a memory that stores computer executable components, and a processor that executes the computer executable components stored in the memory, wherein the computer executable components can comprise a processing component that generates an access rule that modifies access to first data of a graph database, wherein the first data comprises first party information identified as private, a sampling component that executes a random walk for sampling a first graph of the graph database while employing the access rule, wherein the first graph comprises the first data, and an inference component that, based on the sampling, generates a prediction in response to a query, wherein the inference component avoids directly exposing the first party information in the prediction.

In accordance with another embodiment, a computer-implemented method can comprise generating, by a system operatively coupled to a processor, an access rule that modifies access to first data of a graph database, wherein the first data comprises first party information identified as private, executing, by the system, a random walk for sampling a first graph of the graph database while employing the access rule, wherein the first graph comprises the first data; and based on the sampling, generating, by the system, a prediction in response to a query, wherein the generating comprises avoiding directly exposing the first party information in the prediction.

In accordance with yet another embodiment, a computer program product facilitating a process for privacy-enhanced machine learning and inference, the computer program product comprising a computer readable storage medium having program instructions embodied therewith, the program instructions executable by a processor to cause the processor to generate, by the processor, an access rule that modifies access to first data of a graph database, wherein the first data comprises first party information identified as private, execute, by the processor, a random walk for sampling a first graph of the graph database while employing the access rule, wherein the first graph comprises the first data, and based on the sampling, generate, by the processor, a prediction in response to a query, wherein the generating comprises avoiding directly exposing the first party information in the prediction.

An advantage of the above-indicated system, computer-implemented method and/or computer program product can be providing for maintaining of privacy of private information of a graph database during any one or more of training of a predictive model or use of a predictive model to respond to a query. That is, although the predictive model can be employed by a plurality of entities and/or shared, use of the predictive model does not result in exposure of private data. This can be useful in the fields of healthcare, finances and/or social networking where maintaining privacy of data can be desired, contracted and/or legally regulated.

Another advantage of the above-indicated system, computer-implemented method and/or computer program product can be an ability to train a predictive model employing a differential privacy-stochastic gradient descent approach, even where data from one record, one entity and/or one neighbor influences data from multiple other records, entities and/or neighbors (e.g., where a plurality of nodes of a respective graph database are interconnected with one another).

Put another way, differential privacy can be challenging to implement in existing systems, and the above-indicated system, computer-implemented method and/or computer program product can enable application of differential privacy (DP) for complex but existing model types such as, but not limited to graph neural networks (GNNs). In connection with this advantage, DP-training of existing models like GNNs can aid in enabling federated learning scenarios. For example, multiple organizations can collaborate by sharing a single DP-protected model and/or its updated versions.

Another advantage of the above-indicated system, computer-implemented method and/or computer program product can the provision of a practical strategy for configuring a privacy budget which can be a shortcoming of differential privacy approaches in existing frameworks.

In one or more embodiments of the aforementioned system, computer-implemented method and/or computer program product, the access rule comprises at least one of a limit on a quantity of visits to a node or an edge of the graph database or a perturbance of the graph database with additional data. An advantage of this feature can be at least partially modifying access to the first party information.

### DESCRIPTION OF THE DRAWINGS

FIG. 1 illustrates a block diagram of an example, non-limiting system that can provide a process to train a machine learning model and provide inference, in accordance with one or more embodiments described herein.

FIG. 2 illustrates a block diagram of another example, non-limiting system that can provide a process to train a machine learning model and provide inference, in accordance with one or more embodiments described herein.

FIG. 3 illustrates a graph database that can be employed by the non-limiting system of FIG. 2, in accordance with one or more embodiments described herein.

FIG. 4 illustrates a block flow diagram of example access rules that can be generated by the non-limiting system of FIG. 2, in accordance with one or more embodiments described herein.

FIG. 5 illustrates a block flow diagram of example processes for training a machine learning model, employing the non-limiting system of FIG. 2, in accordance with one or more embodiments described herein.

FIG. 6 depicts a set of graphs illustrating sliding and dilation as employed for determining a noise distribution to be employed by the non-limiting system of FIG. 2 to satisfy a privacy budget, in accordance with one or more embodiments described herein.

FIG. 7 illustrates a block flow diagram of a summary of example processes for training a machine learning model and generating a prediction, employing the non-limiting system of FIG. 2, in accordance with one or more embodiments described herein.

FIG. 8 illustrates a flow diagram of one or more processes that can be performed by the non-limiting system of FIG. 2, in accordance with one or more embodiments described herein.

FIG. 9 illustrates a continuation of the flow diagram of FIG. 8 of one or more processes that can be performed by the non-limiting system of FIG. 2, in accordance with one or more embodiments described herein.

FIG. 10 illustrates a block diagram of example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A goal of private data analysis (e.g., of data identified as private and not to be shared) can be to release aggregate information about a data set while protecting the privacy of entities whose information the data set comprises. This goal can be desirable in various environments including, but not limited to, social networking forecasting, healthcare forecasting, financial forecasting, social influence forecasting and/or commercial trend forecasting.

To perform such forecasting, graph data is often used in existing data analytics processes. The graph data can be used, for instance, to solve problems related to pandemic forecasting, social influence prediction and/or vaccination likelihood. Existing techniques, such as stochastic gradient descent (SGD), can be employed to analyze the data. In connection therewith, existing techniques, such as differential privacy (DP) can be employed to aid in protecting information of the graph data that is private.

However, existing techniques fail when employing graph data where data from one record, one entity and/or one neighbor influences data from multiple other records, entities and/or neighbors. This influence can occur in cases where nodes of the graph data are connected due to influence from other nodes. In such cases existing DP techniques will not be sufficient, where combined with SGD, because SGD is not privacy protective. That is, privacy of data will not be protected or implemented. Indeed, determination of a privacy budget and even maintaining privacy of information separate from determine of such privacy budget can be complex and in existing frameworks leads to leakage of such private information. This leakage can be undesirable let alone counter to a contract, regulation and/or law.

To account for one or more of these deficiencies of existing frameworks, one or more embodiments are described herein that can employ a graph database that can comprise data comprising private information to output a prediction based on data of the graph database. The data on which the prediction is based comprises at least a portion of first data comprising the private information, referred to herein as first party information. That is, the label “first party” is employed where a second party can be an entity submitting a query and requesting the prediction.

The graph database can additionally comprise public data, such as data not considered to be private data.

Associated with the graph database can be graph embeddings. These graph embeddings can be models that take as input the graph database x and output matrices and/or vectors. The graph embeddings are dependent on a structure of the graph database. These graph embeddings are public in that they do not directly comprise the private data and further can be prepared and shared publicly.

A query can comprise any request for information such as a forecasting request. As one example, a hospital or administrative unit entity with access to user contact information can desire to learn a forecasting model for pandemic forecasting. As another example, a non-profit organization entity with access to private data of its user may desire to learn a forecasting model for influencing direction of its members.

In general, the graph database can be employed, along with privacy-enhancing techniques of a privacy-enhancing prediction system to train a predictive model, such as a predictive machine learning model. The predictive model can then be shared with various entities and thus can be a public predictive model. Even though the predictive model can be public and can be based (e.g., trained) at least partially on private data, the privacy-enhancing prediction system embodiments described herein can train the predictive model in such a way that privacy of the private data is ensured, such as where leakage of private data is greatly reduced as compared to existing techniques and/or altogether prevented with respect to use of the predictive model.

Generally, one or more processes that can be employed by the privacy-enhancing prediction system to train the predictive model and to ensure privacy of private data on which the predictive model is based can include the following, but are not limited to these processes only: generating one or more access rules that modify access to the first data of the graph database, wherein the first data comprises the first party information identified as private; executing random walks with restart probabilities; determining a privacy budget that restricts and/or prevents leakage of private data (e.g., including the first data); training the predictive model based on a DP-SGD approach using the privacy budget; employing a set of vectors determined based on public graph embeddings of the graph database to assist in training the predictive model. These processes will each be described below in detail.

Put another way, one or more embodiments described herein can allow for determination of a privacy budget to employ in training a machine learning model for predictive analysis. This can comprise allowing for release of functions ƒ of the data with instance-specific additive noise. That is, the noise magnitude can be determined not only by the function to be released, but also by a graph database (of the data set). Indeed, a challenge that is not met by existing frameworks analyzing graph databases is to ensure that the noise magnitude employed does not cause leakage of information about the graph database.

The one or more embodiments described herein can address this deficiency by calibrating the noise magnitude to a smooth sensitivity of the function ƒ based on the graph database x, where the smooth sensitivity is a measure of variability of ƒ in the neighborhood of the graph database x. The one or more embodiments described herein can provide a generic procedure based on sampling that can allow for release of a function ƒ(x) on various graph databases x, even where no efficient algorithm for approximating smooth sensitivity of ƒ is known or where ƒ is provided only as a closed box, thus allowing for determination of a privacy budget on which to train a respective predictive machine learning model.

Upon training of the predictive model, the predictive model can be retrieved and employed to respond to one or more queries by providing one or more predictions based on the graph database x. Retraining of the predictive model can be performed at any suitable frequency based on changes to the graph database, based on addition of another graph database and/or based on one or more outputs of the predictive model which can be employed as historical data by the predictive model.

### Terminology

As used herein, the term “cost” can refer to money, power, memory, bandwidth, time and/or manual labor.

As used herein, the terms “entity,” “requesting entity,” and “user entity” can refer to a machine, device, component, hardware, software, smart device, party and/or human.

As used herein, the term “private” can refer to an aspect that is not to be shared with other entities.

As used herein, the term “private data” can comprise the “first data” and thus can comprise “first party information” considered as private.

As used herein, the term “satisfy,” as in satisfaction of a threshold, can refer to meeting and or exceeding such threshold.

### DESCRIPTION

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

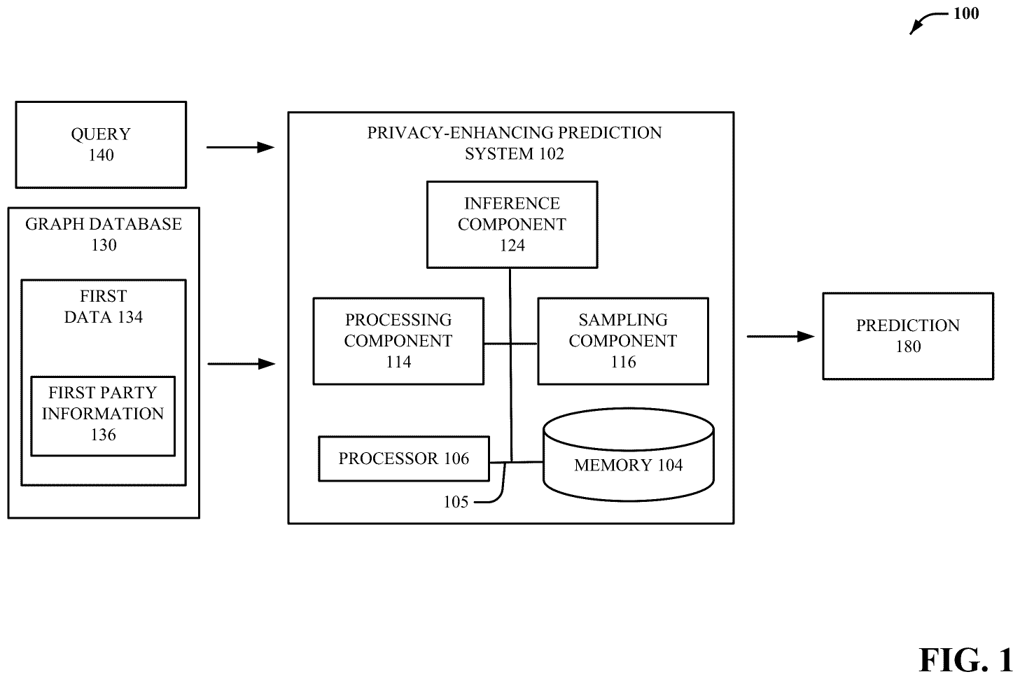

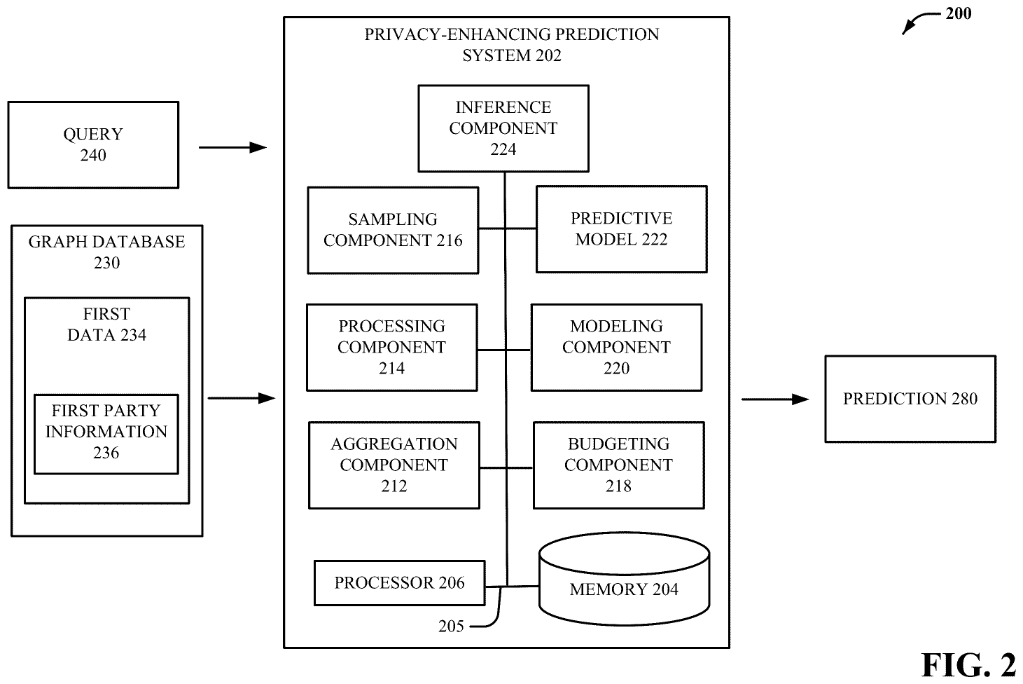

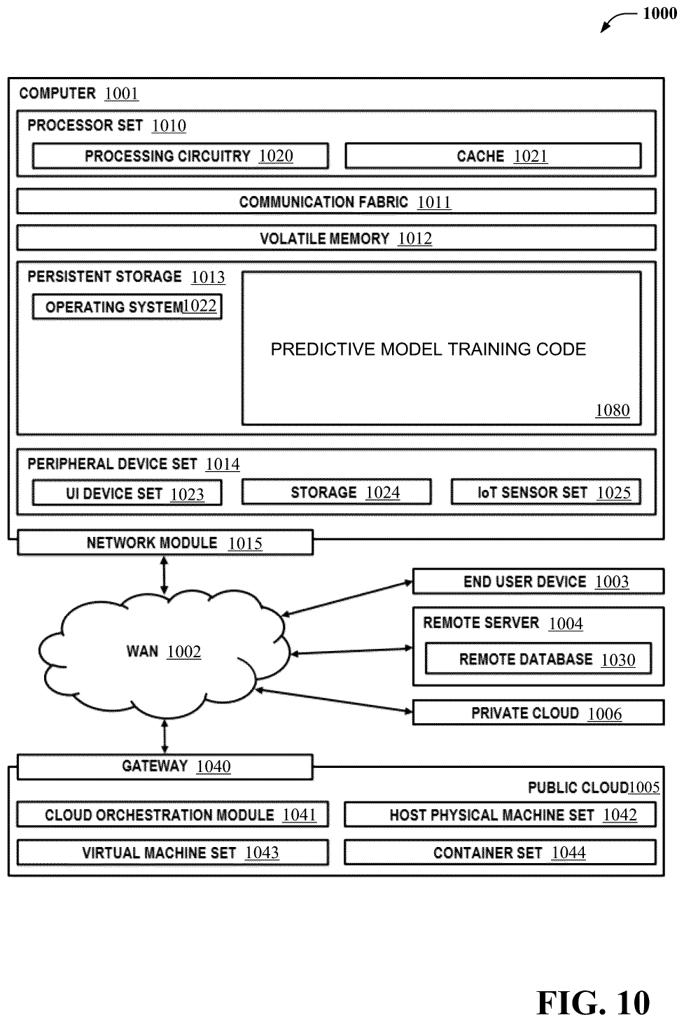

For example, in one or more embodiments, the non-limiting systems 100 and/or 200 illustrated at FIGS. 1 and 2, and/or systems thereof, can further comprise one or more computer and/or computing-based elements described herein with reference to a computing environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIGS. 1 and/or 2 and/or with other figures described herein.

Turning now in particular to one or more figures, and first to FIG. 1, the figure illustrates a block diagram of an example, non-limiting system 100 that can facilitate a process to train a predictive model and to employ the predictive model to output a prediction, where the training and prediction are privacy-enhanced by a privacy-enhancing prediction system 102.

The non-limiting system 100 can comprise a graph database 130 and the privacy-enhancing prediction system 102.

It is noted that the privacy-enhancing prediction system 102 is only briefly detailed to provide but a lead-in to a more complex and/or more expansive privacy-enhancing prediction system 202 as illustrated at FIG. 2. That is, further detail regarding processes that can be performed by one or more embodiments described herein will be provided below relative to the non-limiting system 200 of FIG. 2.

Still referring to FIG. 1, the graph database 130 can comprise first data 134 which can comprise first party information 136 considered to be and/or identified as private. Thus, the graph database 130 comprises private data. In one or more embodiments, the graph database 130 further can comprise public data (e.g., data considered not to be private).

The privacy-enhancing prediction system 102 can comprise at least a memory 104, bus 105, processor 106, processing component 114, sampling component 116 and inference component 124. Using these components, the privacy-enhancing prediction system 102 can output a prediction 180 based on the graph database 130, where the prediction 180 does not expose the first party information 136 to a user entity of the privacy-enhancing prediction system 102 (e.g., a recipient of the prediction 180).

The processing component 114 can generally generate an access rule that can modify access to the first data 134 of the graph database 130. The sampling component 116 can generally execute a random walk for sampling a first graph of the graph database 130 while employing the access rule, where the first graph comprises the first data 134. Based on the sampling, the inference component 124 can generate a prediction in response to a query 140, where the inference component 124 avoids directly exposing the first party information in the prediction.

The processing component 114, sampling component 116 and inference component 124 can be operatively coupled to a processor 106 which can be operatively coupled to a memory 104. The bus 105 can provide for the operative coupling. The processor 106 can facilitate execution of the processing component 114, sampling component 116 and inference component 124. The processing component 114, sampling component 116 and inference component 124 can be stored at the memory 104.

Turning next to FIG. 2, a non-limiting system 200 is illustrated that can comprise a privacy-enhancing prediction system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The privacy-enhancing prediction system 202 can be associated with, such as accessible via, a cloud computing environment.

The privacy-enhancing prediction system 202 can comprise a plurality of components. The components can comprise a memory 204, processor 206, bus 205, aggregation component 212, processing component 214, sampling component 216, budgeting component 218, modeling component 220, predictive model 222 and inference component 224. Using these components, the privacy-enhancing prediction system 202 can output a prediction 280 based on the graph database 230 and in response to a query 240, where the prediction 280 does not expose the first party information 236 to a user entity of the privacy-enhancing prediction system 202 (e.g., a recipient of the prediction 280). The query 240 can be requested by an entity that is not privy to the first party information 236.

The graph database 230 can comprise first data 234 which can comprise first party information 236 considered to be and/or identified as private. Thus, the graph database 230 comprises private data. In one or more embodiments, the graph database 230 further can comprise public data (e.g., data considered not to be private).

Discussion next turns briefly to the processor 206, memory 204 and bus 205 of the privacy-enhancing prediction system 202. For example, in one or more embodiments, the privacy-enhancing prediction system 202 can comprise the processor 206 (e.g., computer processing unit, microprocessor, classical processor, quantum processor and/or like processor). In one or more embodiments, a component associated with privacy-enhancing prediction system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the aggregation component 212, processing component 214, sampling component 216, budgeting component 218, modeling component 220, predictive model 222 and inference component 224.

In one or more embodiments, the privacy-enhancing prediction system 202 can comprise the computer-readable memory 204 that can be operably connected to the processor 206. The memory 204 can store computer-executable instructions that, upon execution by the processor 206, can cause the processor 206 and/or one or more other components of the privacy-enhancing prediction system 202 (e.g., aggregation component 212, processing component 214, sampling component 216, budgeting component 218, modeling component 220, predictive model 222 and inference component 224) to perform one or more actions. In one or more embodiments, the memory 204 can store computer-executable components (e.g., aggregation component 212, processing component 214, sampling component 216, budgeting component 218, modeling component 220, predictive model 222 and inference component 224).

The privacy-enhancing prediction system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the privacy-enhancing prediction system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the privacy-enhancing prediction system 202 and/or of the non-limiting system 200 can reside in the cloud, and/or can reside locally in a local computing environment (e.g., at a specified location).

In addition to the processor 206 and/or memory 204 described above, the privacy-enhancing prediction system 202 can comprise one or more computer and/or machine readable, writable and/or executable components and/or instructions that, when executed by processor 206, can provide performance of one or more operations defined by such component and/or instruction.

Turning now to the additional components of the privacy-enhancing prediction system af202 (e.g., aggregation component 212, processing component 214, sampling component 216, budgeting component 218, modeling component 220, predictive model 222 and inference component 224), generally, the privacy-enhancing prediction system 202 can generate and/or train the predictive model 222, which can then be employed by the privacy-enhancing prediction system 202 to output a prediction 80 in response to a query 240. It is noted that while the predictive model 222 is illustrated as being comprised by the privacy-enhancing prediction system 202, in one or more other embodiments, the predictive model 222 can be external to, but accessible by, the privacy-enhancing prediction system 202.

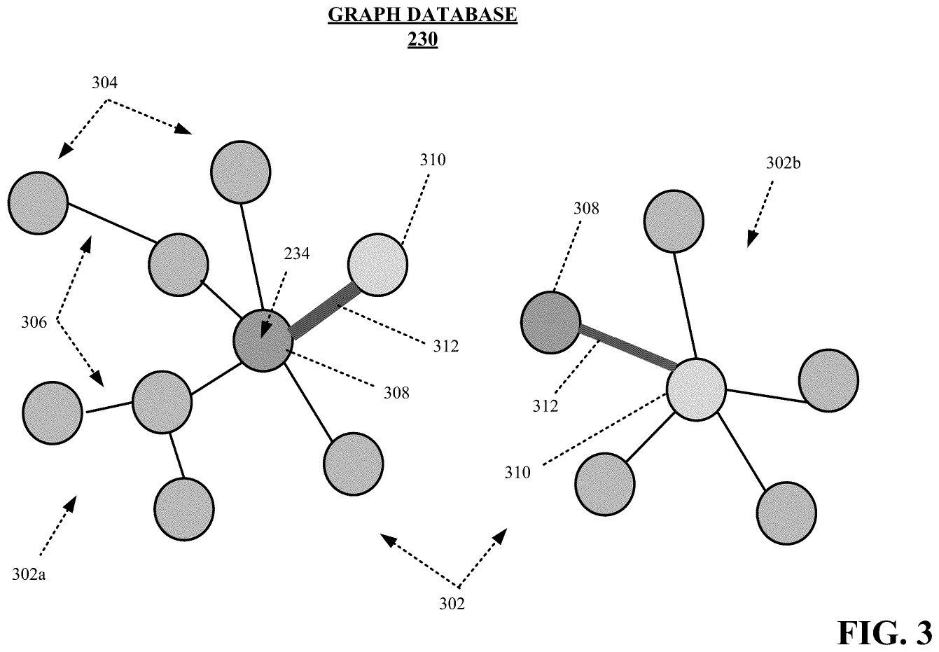

Turning first to the aggregation component 212 and to FIG. 3 in combination with FIG. 2, the aggregation component 212 can identify, search, receive, transfer and/or otherwise obtain the graph database 230. As illustrated at FIG. 3, the graph database 230 can comprise a plurality of graphs 302, such as graph 302a and graph 302b. Each graph 302 can comprise a plurality of nodes 304 and edges 306 connecting nodes 304. Each node 304 can represent a record, entity, party or individual and thus can comprise data defining that record, entity, party or individual. Each node 304 can comprise private data and/or public data.

Relative to the illustrative example used herein, at graph 302a, a first node 308 can comprise private data such as the first data 234. A second node 310 can be influenced (e.g., represented as influence edge 312) by the first node 308. Turning to graph 302b, differently, the first node 308 can be influenced by the second node 310. That is, generally, multiple entities represented as nodes (e.g., records) can affect (e.g., influence) one another and thus are interconnected by this influence. As a result, existing techniques for DP-SGD for training a predictive model will fail to prevent leakage of data due to the connections. That is, the interconnections break the typical assumption required by DP-SGD of each node (record) being independent (e.g., having no influence on one another). Typical application of DP-SGD will therefore fail to reach the desired privacy guarantee.

The aggregation component 212, upon identifying the graph database 230 and its contents, can identify the first data 234 as private, such as by a label and/or tag of the first data 234 and/or by metadata associated with the first data 234. Likewise, the aggregation component 212 can identify second data of the second node 310 as also being private. It is noted that one or more additional nodes 304 of the graphs 302 can comprise public data (e.g., non-private data).

In one or more embodiments, the aggregation component 212 can obtain and/or generate a set of graph embeddings for the graph database 230. These graph embeddings can be models that take as input a graph database x (230) and output matrices and/or vectors. The graph embeddings are dependent on a structure of the graph database from which the graph embeddings are derived. These graph embeddings are public in that they do not directly comprise the private data and further can be prepared and shared publicly. Where the graph embeddings are not already available, the aggregation component 212 can employ the graph database 230 and its structure to generate the graph embeddings. A result of the graph embeddings, such as a set of vectors, can be employed by the modeling component 220 (to be discussed in detail below) to train the predictive model 222.

Using graph embeddings can focus the training of the predictive model 222 on specific characteristics of the graph. It is appreciated, however, that these graph embedding steps can be omitted but if executed, can enhance the privacy of the first data 234 and/or other private data of the graph database 230. As a result, not using graph embeddings would require more data being consumed, e.g., the data instead used can be less concentrated. Training on graph data that is rawer (e.g., as compared to graph embeddings) can take longer, require more computing power, memory and/or energy, and/or be of a much higher dimension, thereby making it more difficult to achieve privacy for the privacy-enhancing prediction system 202.

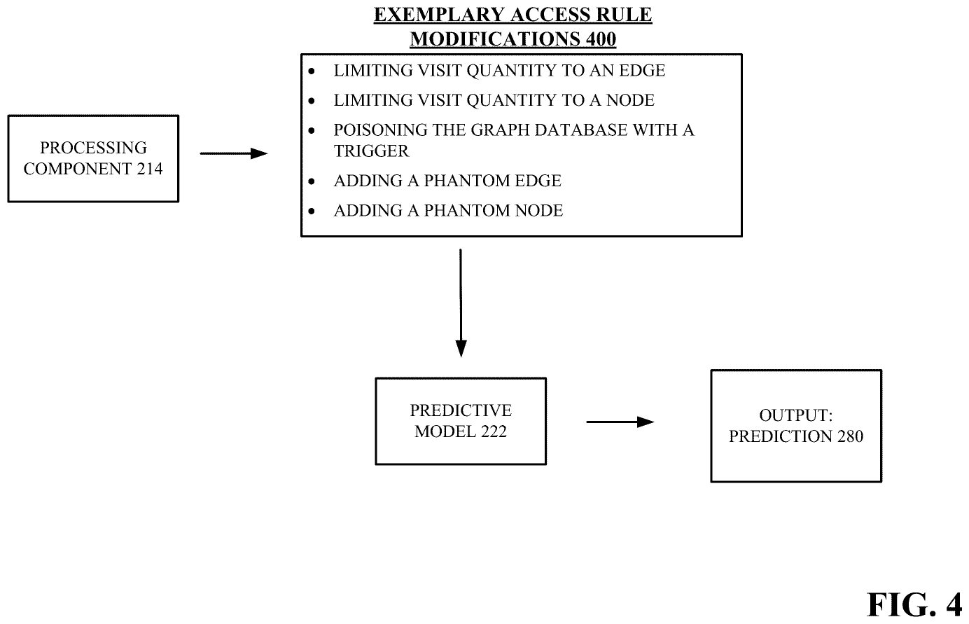

Turning next to the processing component 214 and FIG. 4, along with still referring to FIG. 2, the processing component 214 generally can generate an access rule that modifies access to the first data 234 of the graph database 230, where the first data 234 comprises the first party information 236 identified as private by the aggregation component 212. The access rule can comprise one or more modifications. As illustrated at FIG. 4, exemplary access rule modifications 400 can comprise, but are not limited to: limiting a visit quantity to an edge of a node, limiting a visit quantity to a node, poisoning at least a portion of the graph database with a trigger, adding a phantom edge to the graph database and/or adding a phantom node to the graph database.

A phantom edge or node can be one which is added to the graph at random to obfuscate the data and introduce uncertainty to protect the private information (e.g., first party information 236). Put one way, introduction of a phantom node or edge can introduce a general concept of plausible deniability.

The processing component 214 can generate more than one access rule for a graph database 230. For example, a first access rule can be generated relative to a first node 308, and a second access rule can be generated relative to a second node 310, where the first access rule comprises at least one modification 400 that is different from the one or more modifications 400 of the second access rule. That is, additionally, an access rule can comprise more than one modification 400.

These access rules can be generated, e.g., by the processing component 214, before training and/or use of a predictive model 222 and/or before sampling of the graph database in response to a query 240. That is, these access rules can serve to limit the use of private information of a record/entity/node of the graph database 230. Further, these access rules can ensure that the sensitivity of node level information is captured, such as the contribution of a single node to a final representation across multiple training instances, such as used during batch learning.

That is, to calibrate the noise density used in the training process by the modeling component 220, the contribution of any one node to the training needs to be limited. By limiting the contribution of any one node to the training process, the sensitivity of each node can be calculated and the noise density calibrated based thereon. As will be described below, noise density is used relative to determination of noise distribution.

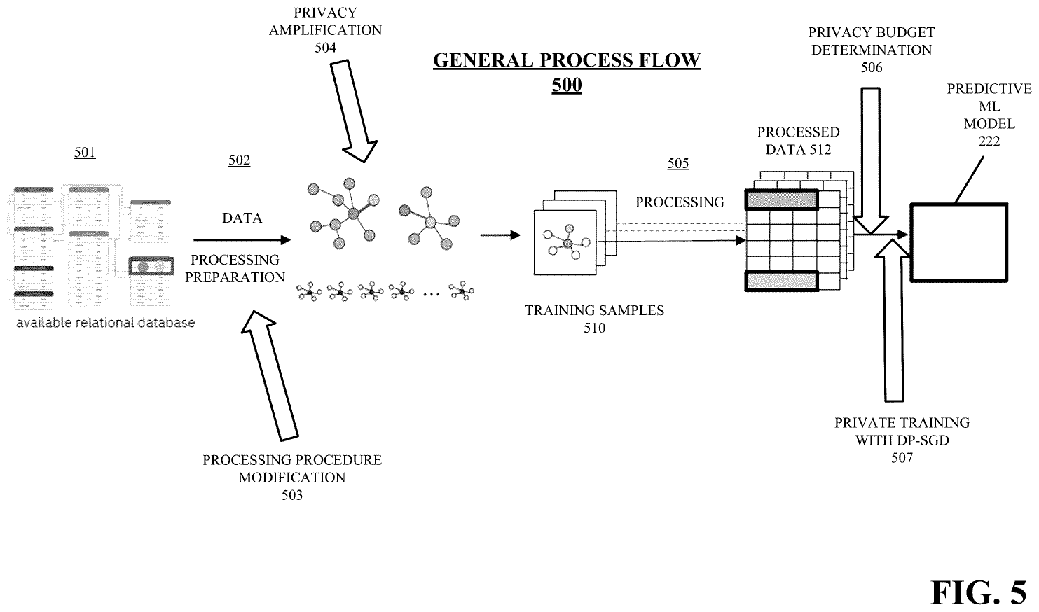

Turning next briefly to FIG. 5, but still referring to FIG. 2, the processing procedure modification step 503 (e.g., modification of a processing procedure for processing the graph database 230) that is performed by the processing component 214 is but one element of privacy-enhancement executed by the privacy-enhancing prediction system 202 to train a predictive machine learning (ML) model 222.

As illustrated at FIG. 5, a general process flow 500 for training a predictive model can comprise identifying an available relational database (e.g., graph database 230) on which to train a predictive model 222 (e.g., at step 501). Step 502 can comprise processing of data of the graph database. Step 503 can comprise the modification of the processing procedure (e.g., for processing the graph database) by the processing component 214. Step 504 can comprise use of the one or more access rules generated by the processing component 214 by the sampling component 216 for implementing further privacy amplification of the graph database, and particularly of the private data (e.g., first data 234).

The sampling component 216 generally can leverage one or more inherent benefits of sampling for use in amplifying privacy-enhancement of the identified private data. For example, the sampling component 216 can execute one or more random walks for sampling graphs of the graph database 230 while employing the access rules generated relative to the data (e.g., nodes) of the graph database 230. Indeed, the one or more access rules are applied to each application of the random walk. Accordingly, all uses of the graph database 230 for training the predictive model 222 is done using the one or more access rules. Further, the random walks can be executed by the sampling component 216 using a restart probability, which can provide for uniformity in terms of neighborhood size relative to the training samples 510 and processed data 512 (FIG. 5), among other benefits.

A restart probability can be defined as a probability with which the random walk resets to the original starting node before continuing the random walk. This can ensure that the random walk does not extend far beyond the starting node, and that the sampling component 216 is able to better capture the local structure around the starting node. A low restart probability (e.g., close to 0) will result in nodes far away from the starting node being included in the random walk. A high restart probability (e.g., close to 1) will result in the random walk only including nodes close to the starting node. The restart probability can be determined by and input by an administrator entity (e.g., curator of the data) operating the privacy-enhancing prediction system 202, for example.

An output of step 504 can be a set of training samples 510. Depending on the one or more access rules employed, the training samples 510 can, for example, have restricted edge contributions, phantom data, or even poisoned data.

At step 505, the sampled data, sampled by the sampling component 216, can be further processed, such as by the sampling component 216, into resultant processed data 512. This further processing can comprise aggregation of the sampling results into one or more graphs, tables and/or other formats for use by the modeling component 220 in training the predictive model 222.

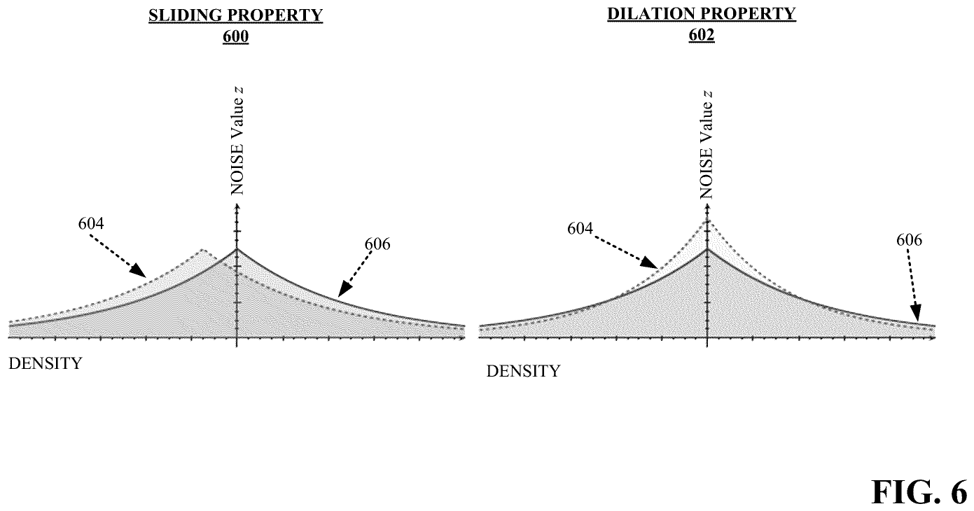

Turning now to the budgeting component 218 and the graphs 600 and 602 of FIG. 6, a practical strategy for configuring a privacy budget for use in a differential privacy-stochastic gradient descent approach (DP-SGD) for training the predictive model 222 will be generally detailed.

Generally, the budgeting component 218 can determine a privacy budget that comprises a noise distribution to be employed by the modeling component 220 to train the predictive model 222. That is, the budgeting component 218 can determine the noise distribution as set forth below, which noise distribution can comprise a scale relative to a degree of spread of the noise distribution. This determination can comprise calibrating noise according to smooth upper bounds. Put another way, the determination can comprise selection of a noise distribution so that adding noise proportional to a smooth upper bound on the local sensitivity, in connection with the DP-SGD approach of step 507, results in a differentially private algorithm to be employed by the predictive ML model 222.

In an exemplary smooth sensitivity framework, the noise magnitude is proportional to

$$\frac{{s}_{f} ( x )}{α} ,$$

where S_{ƒ} is a β-smooth upper bound on the local sensitivity of ƒ, and α, β are parameters of the noise distribution.

For functions that return a single real value, a concrete bound can be obtained, such as by using the budgeting component 218.

A concrete bound that can be obtained can be defined as a 1-dimensional case. In such case, let ƒ: Dⁿ→ [symbol] be any real-valued function and let S: Dⁿ→ [symbol] be a β-smooth upper bound on the local sensitivity of ƒ. Then:
1. If

$$β \leq \frac{ϵ}{2 ( γ + 1 )} and γ > 1 ,$$

the algorithm

$$x ↦ f ( x ) + \frac{2 ( γ + 1 ) S ( x )}{ϵ} \cdot η ,$$

where η is sampled from the distribution with density

$$h ( z ) ∝ \frac{1}{\text{?}} .$$

$$\text{?} \text{indicates text missing or illegible when filed}$$

is ϵ-differentially private.
2. If

$$β \leq \text{?} and δ ∈ ( 0 , 1 ) ,$$

$$\text{?} \text{indicates text missing or illegible when filed}$$

the algorithm

$$x ↦ f ( x ) + \frac{2 S ( x )}{ϵ} \cdot η ,$$

where η˜Lap(1), is (ϵ, δ)-differentially private.

For functions taking values in [symbol] ^{d}, the situation can be more complicated because the smoothing parameter β can depend on d as well as ∈ and δ. Moreover, there are many natural choices of metrics with respect to which sensitivity can be measured.

As an aside, it is noted that for a subset S of [symbol] ^{d}, S+Δ can be written for the set {z+Δ|z∈S}, and e^{λ}·S for the set {e^{λ}·z|z∈S}. Additionally, a+b for the interval [a−b, a+b].

As a first step, an admissible noise distribution can be defined as follows. A probability distribution on [symbol] ^{d}, given by a density function h, is (α, β)-admissible (with respect to [symbol] ₁) if, for α=α(ϵ, δ), β=β(ϵ, δ), the following two conditions hold for all Δϵ [symbol] ^{d} and λϵ [symbol] satisfying ∥Δ∥₁≤α and |λ|≤β, and for all measurable subsets S⊆ [symbol] ^{d}:

$$Sliding Property : {Pr}_{Z \sim h} [ Z ∈ S ] \leq \text{?} \cdot {Pr}_{Z \sim h} [ Z ∈ S + Δ ] + \text{?} .$$

$$Dilation Property : {Pr}_{Z \sim h} [ Z ∈ S ] \leq \text{?} \cdot {Pr}_{Z \sim h} [ Z ∈ {e}^{λ} \cdot S ] + \text{?} .$$

$$\text{?} \text{indicates text missing or illegible when filed}$$

This definition requires the noise distribution to not change much under translation (sliding) and under scaling (dilation). For example, turning to FIG. 6, sliding is illustrated at graph 600 and dilation is illustrated at graph 602. At the graphs, sliding and dilation, respectively, for the Laplace distribution with probability density function (p.d.f.)

$$h ( z ) = \frac{1}{2} {e}^{- \vert z \vert} ,$$

plotted as the solid lines 606. The dotted lines 604 plot the density h(z+0.3) for the sliding graph 600 and e^{0.3}h(e^{0.3}z) for the dilation graph 602 with respect to the noise value z.

Discussion next turns to the predictive model 222 and to the modeling component 220.

The predictive model 222 can comprise and/or can be comprised by a classical model, neural network, and/or artificial intelligent model. An artificial intelligent model and/or neural network (e.g., a convolutional network and/or deep neural network) can comprise and/or employ artificial intelligence (AI), machine learning (ML), and/or deep learning (DL), where the learning can be supervised, self-supervised, semi-supervised and/or unsupervised. For example, the predictive model 222 can be and/or can comprise an ML model.

Generally, the predictive model 222 can be trained, such as by the modeling component 220, on the processed data 512, which processed data 512 has been privacy-enhanced in view of at least the modification of the processing procedure at step 503 and the privacy amplification provided by the use of sampling with random walks using restart probabilities at step 504. Using the processed data 512 and using the set of vectors from the graph embeddings output by the aggregation component, the modeling component 220 can train the predictive model 522 using a differential privacy-stochastic gradient descent approach (DP-SGD), e.g., at step 507 of the general process flow 500 illustrated at FIG. 5.

Generally, DP-SGD, accompanied by the aforementioned privacy-enhancing processes, can be used to protect entity-level (e.g., node-level) privacy of private information (e.g., first party information 236). Indeed, use of the DP-SGD approach, accompanied by the aforementioned privacy-enhancing processes, can allow for restriction and/or full prevention of data leakage of private data (e.g., the first data 234) during sharing and/or use of the predictive model 222.

In one or more embodiments, further training and/or fine-tuning of the predictive model 222 can be executed by the modeling component 220 at any suitable frequency, such as on demand, upon identification of changes to the graph database 230 (e.g., by the aggregation component 212), upon identification of a new related graph database (e.g., by the aggregation component 212), and/or after an iteration of generation of a prediction to a query. For example, a prediction and any data/metadata output therewith can be employed by the modeling component 220 as historical data on which to train the predictive model 222 for better recognizing trends, such as relative to one or more future iterations of querying and predicting.

The predictive model 222, once trained, can be used/executed. The use can include querying the predictive model 222. Alternatively, the predictive model 222 can be employed/shared in a federated learning approach whereby varying predictive models 222 and/or predictive model updates are aggregated to output a resultant and aggregated predictive model. Both sharing and execution of the predictive model 222, in view of the processes described above, can result in non-leakage of private data and/or private information of such private data.

For example, turning next to the inference component 224, the trained predictive model 222 can be employed by the privacy-enhancing prediction system 202, such as by the inference component 224. That is, the inference component 224 can employ the predictive model 222 to respond to a query 240 by outputting a prediction 280.

In use, the predictive model 222 can employ the access rules to sample a graph database 230, which can be a different and/or the same as the graph database 230 employed by the privacy-enhancing prediction system 202 to train the predictive model 222. That is, the predictive model 222 can have already been trained on the access rules by the modeling component 220. The predictive model 222 can then generate a prediction 280.

For example, in training of the predictive model 222, the respective algorithm can learn various parameters to allow the predictive model 222 to fit a given example to its corresponding class as best as possible across all examples. Having trained the predictive model 222, the predictive model 222 can then be fed, e.g., by the inference component 224, examples without a known classification, and the predictive model 222 will use its learned parameters to make a prediction as to the example's class.

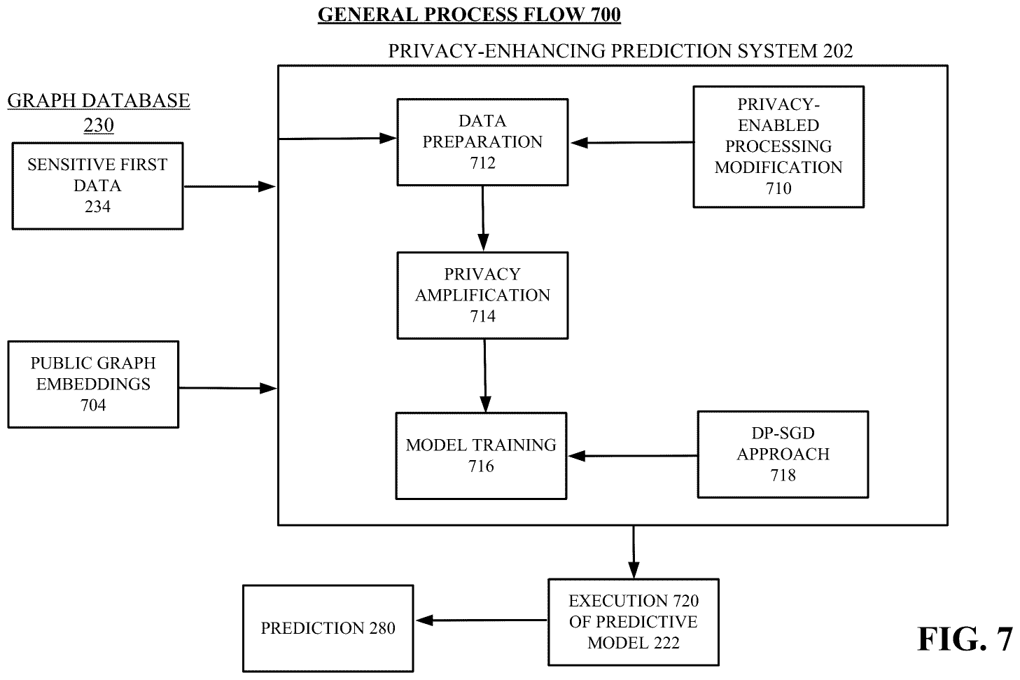

To provide a summary, FIG. 7 illustrates a process flow 700 for training and using a predictive model 222.

At step 710, privacy-enabled processing modification 710 can be performed by the processing component 214, as described above, using the sensitive first data 234 and the graph database 230. An output of step 710 can be one or more access rules. These one or more access rules can be employed by the sampling component 216 or aggregation component 212 for data preparation at step 712. The data preparation can provide the data of the graph database 230 in a form suitable for sampling by the sampling component 216.

At step 714, the sampling component 216 can perform privacy amplification of data of the graph database. This can comprise executing one or more random walks with one or more restart probabilities.

At step 716, the modeling component 720 can train the predictive model 222 based on the processed data 512 output from the privacy amplification sampling step 714. In one or more embodiments, the modeling component 720 further can employ public graph embeddings 704 that can be identified and/or generated by the aggregation component 212. The training can employ a DP-SGD approach 718 as explained above.

At step 720, the inference component 224 can execute the predictive model 222 to output a prediction 280, such as based on a query 240.

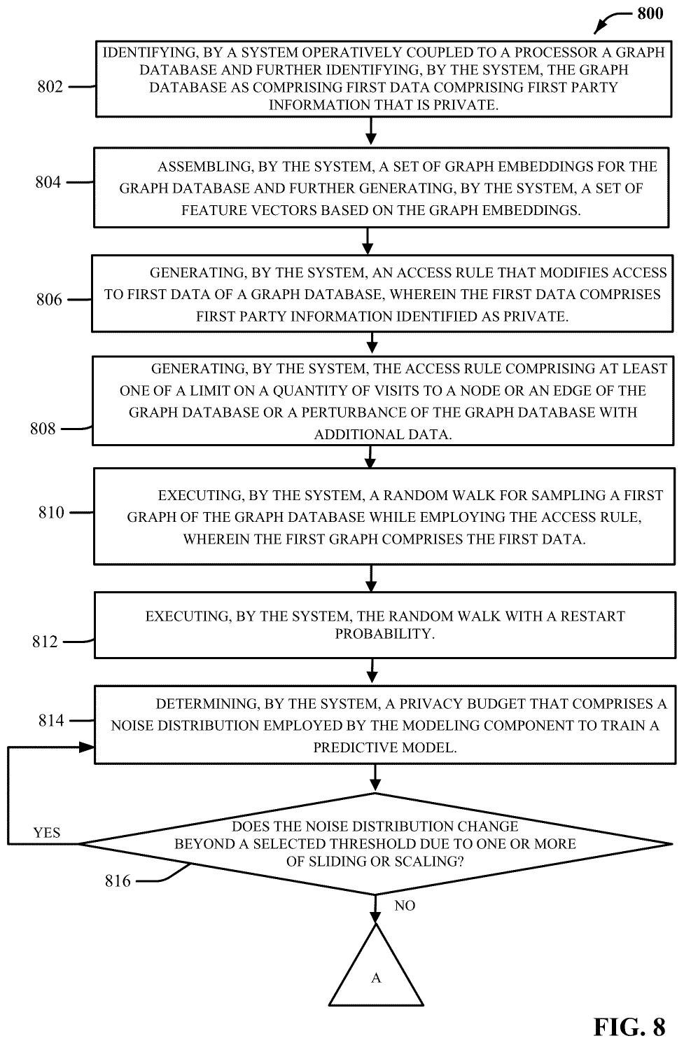

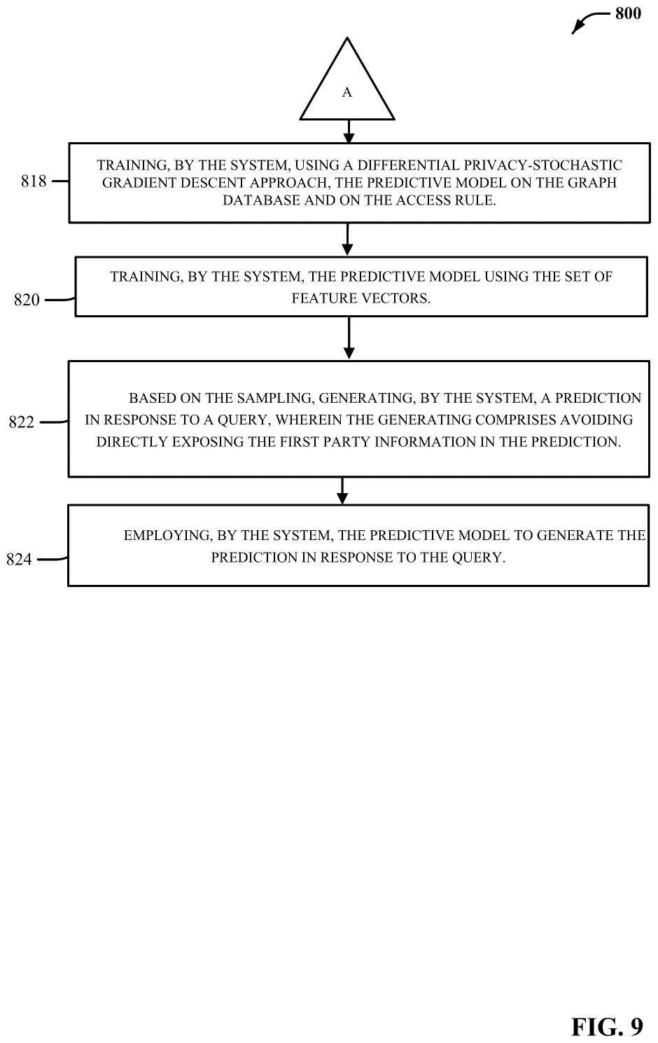

Referring next to FIGS. 8 and 9, illustrated is a flow diagram of an example, non-limiting method 800 that can provide a process train a machine learning model and provide a prediction while employing privacy-enhancing approaches, in accordance with one or more embodiments described herein, such as the non-limiting system 200 of FIG. 2. While the non-limiting method 800 is described relative to the non-limiting system 200 of FIG. 2, the non-limiting method 800 can be applicable also to other systems described herein, such as the non-limiting system 100 of FIG. 1. Repetitive description of like elements and/or processes employed in respective embodiments is omitted for sake of brevity.

At 802, the non-limiting method 800 can comprise identifying, by a system operatively coupled to a processor (e.g., aggregation component 212) a graph database and further identifying, by the system (e.g., aggregation component 212), the graph database as comprising first data comprising first party information that is private.

At 804, the non-limiting method 800 can comprise assembling, by the system (e.g., aggregation component 212), a set of graph embeddings for the graph database and further generating, by the system (e.g., aggregation component 212), a set of feature vectors based on the graph embeddings.

At 806, the non-limiting method 800 can comprise generating, by the system (e.g., processing component 214), an access rule that modifies access to first data of a graph database, wherein the first data comprises first party information identified as private.

At 808, the non-limiting method 800 can comprise generating, by the system (e.g., processing component 214), the access rule comprising at least one of a limit on a quantity of visits to a node or an edge of the graph database or a perturbance of the graph database with additional data.

At 810, the non-limiting method 800 can comprise executing, by the system (e.g., sampling component 216), a random walk for sampling a first graph of the graph database while employing the access rule, wherein the first graph comprises the first data.

At 812, the non-limiting method 800 can comprise executing, by the system (e.g., sampling component 216), the random walk with a restart probability.

At 814, the non-limiting method 800 can comprise determining, by the system (e.g., budgeting component 218), a privacy budget that comprises a noise distribution employed by the modeling component to train a predictive model.

At 816, the non-limiting method 800 comprises determining, by the system (e.g., budgeting component 218) whether the noise distribution changes beyond a selected threshold due to one or more of sliding of scaling. If the change does satisfy the selected threshold, the non-limiting method 800 proceeds back to step 814. If the change does not satisfy the selected threshold, the non-limiting method 800 proceeds to step 818.

At 818, the non-limiting method 800 can comprise training, by the system (e.g., modeling component 220), using a differential privacy-stochastic gradient descent approach, the predictive model (e.g., predictive model 222) on the graph database and on the access rule.

At 820, the non-limiting method 800 can comprise training, by the system (e.g., modeling component 220), the predictive model using the set of feature vectors.

At 822, the non-limiting method 800 can comprise, based on the sampling, generating, by the system (e.g., inference component 224), a prediction in response to a query, wherein the generating comprises avoiding directly exposing the first party information in the prediction.

At 824, the non-limiting method 800 can comprise employing, by the system (e.g., inference component 224), the predictive model (e.g., predictive model 222) to generate the prediction in response to the query.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, devices, computer program products and/or computer-implemented methods of use provided herein relate to a process for privacy-enhanced machine learning and inference. A system can comprise a memory that stores computer executable components, and a processor that executes the computer executable components stored in the memory, wherein the computer executable components can comprise a processing component that generates an access rule that modifies access to first data of a graph database, wherein the first data comprises first party information identified as private, a sampling component that executes a random walk for sampling a first graph of the graph database while employing the access rule, wherein the first graph comprises the first data, and an inference component that, based on the sampling, generates a prediction in response to a query, wherein the inference component avoids directly exposing the first party information in the prediction.

An advantage of the above-indicated system, computer-implemented method and/or computer program product can be providing for maintaining of privacy of private information of a graph database during any one or more of training of a predictive model or use of a predictive model to respond to a query. That is, although the predictive model can be employed by a plurality of entities and/or shared, use of the predictive model does not result in exposure of private data. This can be useful in the fields of healthcare, finances and/or social networking where maintaining privacy of data can be desired, contracted and/or legally regulated.

Another advantage of the above-indicated system, computer-implemented method and/or computer program product can be an ability to train a predictive model employing a differential privacy-stochastic gradient descent approach, even where data from one record, one entity and/or one neighbor influences data from multiple other records, entities and/or neighbors (e.g., where a plurality of nodes of a respective graph database are interconnected with one another).

Put another way, differential privacy can be challenging to implement in existing systems, and the above-indicated system, computer-implemented method and/or computer program product can enable application of differential privacy (DP) for complex but existing model types such as, but not limited to graph neural networks (GNNs). In connection with this advantage, DP-training of existing models like GNNs can aid in enabling federated learning scenarios. For example, multiple organizations can collaborate by sharing a single DP-protected model and/or its updated versions.

Another advantage of the above-indicated system, computer-implemented method and/or computer program product can the provision of a practical strategy for configuring a privacy budget which can be a shortcoming of differential privacy approaches in existing frameworks.

Indeed, in view of the one or more embodiments described herein, a practical application of the one or more systems, computer-implemented methods and/or computer program products described herein can be ability to prevent unintended sharing of private information, but rather trained models can instead be shared. Such is a useful and practical application of computers, thus providing enhanced (e.g., improved and/or optimized) privacy whether for a desired purpose, contracted purpose and/or regulated purpose. Overall, such computerized tools can constitute a concrete and tangible technical improvement in the fields of privacy-enhanced data analysis and privacy-enhanced machine learning.

Furthermore, one or more embodiments described herein can be employed in a real-world system based on the disclosed teachings. For example, one or more embodiments described herein can function with a query system, storage system and/or file management system that can receive as input a query and/or file, and which as an output can provide an output prediction while employing a privacy-enhanced trained machine learning model to prevent access to private information accessed by the system.

Moreover, a device and/or method described herein can be implemented in one or more domains to enable scaled model training and/or query responses. Indeed, use of a system as described herein can be scalable, such as where plural inputs graph databases can be evaluated, plural predictive models can be trained and/or plural predictions can be generated at least partially at a same time as one another.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to privacy-enhanced machine learning and inference, as compared to existing systems and/or techniques. Systems, computer-implemented methods and/or computer program products providing performance of these processes are of great utility in the fields of privacy-enhanced data analysis and privacy-enhanced machine learning, and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically train a predictive model employing a DP-SGD approach while providing for privacy enhancement that prevents leakage of private data on which the predictive model is trained as the one or more embodiments described herein can provide this process. Moreover, neither can the human mind nor a human with pen and paper conduct one or more of these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

Turning next to FIG. 10, a detailed description is provided of additional context for the one or more embodiments described herein at FIGS. 1-9.

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the predictive model training code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine that collects and stores helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a processing component that generates an access rule that modifies access to first data of a graph database, wherein the first data comprises first party information identified as private;
a sampling component that executes a random walk for sampling a first graph of the graph database while employing the access rule, wherein the first graph comprises the first data; and
an inference component that, based on the sampling, generates a prediction in response to a query, wherein the inference component avoids directly exposing the first party information in the prediction.

2. The system of claim 1, further comprising:
a modeling component that trains a predictive model on the graph database and on the access rule, wherein the inference component employs the predictive model to generate the prediction in response to the query.

3. The system of claim 2, wherein the sampling component executes the random walk with a restart probability.

4. The system of claim 1, wherein the access rule comprises a limit on a quantity of visits to a node or an edge of the graph database.

5. The system of claim 1, wherein the access rule comprises perturbing the graph database with additional data.

6. The system of claim 1, further comprising:
an aggregation component that assembles a set of graph embeddings for the graph database and that generates a set of feature vectors based on the graph embeddings, wherein the set of feature vectors are employed by the inference component to generate the prediction.

7. The system of claim 2, wherein the modeling component trains the predictive model using a differential privacy-stochastic gradient descent approach.

8. The system of claim 1, further comprising:
a budgeting component that determines a privacy budget that comprises a noise distribution employed by the modeling component to train the predictive model.

9. A computer-implemented method, comprising:
generating, by a system operatively coupled to a processor, an access rule that modifies access to first data of a graph database, wherein the first data comprises first party information identified as private;
executing, by the system, a random walk for sampling a first graph of the graph database while employing the access rule, wherein the first graph comprises the first data; and
based on the sampling, generating, by the system, a prediction in response to a query, wherein the generating comprises avoiding directly exposing the first party information in the prediction.

10. The computer-implemented method of claim 9, further comprising:
training, by the system, using a differential privacy-stochastic gradient descent approach, a predictive model on the graph database and on the access rule; and
employing, by the system, the predictive model to generate the prediction in response to the query.

11. The computer-implemented method of claim 10, further comprising:
executing, by the system, the random walk with a restart probability.

12. The computer-implemented method of claim 9, wherein the access rule comprises at least one of a limit on a quantity of visits to a node or an edge of the graph database or a perturbance of the graph database with additional data.

13. The computer-implemented method of claim 10, further comprising:
assembling, by the system, a set of graph embeddings for the graph database;
generating, by the system, a set of feature vectors based on the graph embeddings; and
employing, by the system, the set of feature vectors to train the predictive model.

14. The computer-implemented method of claim 9, further comprising:
determining, by the system, a privacy budget that comprises a noise distribution employed by the modeling component to train the predictive model.

15. A computer program product facilitating a process for privacy-enhanced machine learning and inference, the computer program product comprising a computer readable storage medium having program instructions embodied therewith, the program instructions executable by a processor to cause the processor to:
generate, by the processor, an access rule that modifies access to first data of a graph database, wherein the first data comprises first party information identified as private;
execute, by the processor, a random walk for sampling a first graph of the graph database while employing the access rule, wherein the first graph comprises the first data; and
based on the sampling, generate, by the processor, a prediction in response to a query, wherein the generating comprises avoiding directly exposing the first party information in the prediction.

16. The computer program product of claim 15, wherein the program instructions are further executable by the processor to cause the processor to:
train, by the processor, using a differential privacy-stochastic gradient descent approach, a predictive model on the graph database and on the access rule; and
employ, by the processor, the predictive model to generate the prediction in response to the query.

17. The computer program product of claim 16, wherein the program instructions are further executable by the processor to cause the processor to:
execute, by the processor, the random walk with a restart probability.

18. The computer program product of claim 15, wherein the access rule comprises at least one of a limit on a quantity of visits to a node or an edge of the graph database or a perturbance of the graph database with additional data.

19. The computer program product of claim 16, wherein the program instructions are further executable by the processor to cause the processor to:
assemble, by the processor, a set of graph embeddings for the graph database;
generate, by the processor, a set of feature vectors based on the graph embeddings; and
employ, by the processor, the set of feature vectors to train the predictive model.

20. The computer program product of claim 15, wherein the program instructions are further executable by the processor to cause the processor to:
determine, by the system, a privacy budget that comprises a noise distribution employed by the modeling component to train the predictive model.
